(19) United States
(12) Patent Application Publication
(10) Pub. No.: US 2017/0280248 A1
(43) Pub. Date: Sep. 28, 2017

(54) MAGNETIC CIRCUIT AND LOUDSPEAKER USING SAME

(71) Applicant: Panasonic Intellectual Property Management Co., Ltd., Osaka (JP)

(72) Inventors: MITSUKAZU KUZE, Osaka (JP); HIDEAKI INOUE, Mie (JP); SATOSHI KOURA, Osaka (JP); TOMONORI SHIBUYA, Osaka (JP); TAKAYUKI DAN, Osaka (JP); TETSUSHI ITANO, Osaka (JP)

(21) Appl. No.: 15/510,901

(22) PCT Filed: Sep. 25, 2015
(86) PCT No.: PCT/JP2015/004872

§ 371 Date: Mar. 13, 2017

(30) Foreign Application Priority Data
Oct. 1, 2014 (JP) 2014-202748

(51) Int. Cl. H04R 9/06; H04R 7/18; H04R 7/12; H04R 9/02

(52) U.S. Cl. CPC H04R 9/06; H04R 9/025; H04R 7/18; H04R 7/127; H04R 2400/11

(57) ABSTRACT

An object of the present disclosure is to provide a loudspeaker with small distortion. In order to achieve the object, a magnetic circuit of the present disclosure includes a yoke having a first facing part and a magnetic part having a second facing part. The magnetic part supplies magnetic force to a magnetic gap. The second facing part faces the first facing part through a magnetic gap. A second upper end of the second facing part is disposed so as to be separated by a first distance from a first upper end of the first facing part. Meanwhile, a second lower end of the second facing part is disposed so as to be separated by a greater distance than the first distance from a first lower end of the first facing part.

### TECHNICAL FIELD

The present disclosure relates to a magnetic circuit mounted in various types of audio equipment and a loudspeaker using the same.

### BACKGROUND ART

Hereinafter, a conventional magnetic circuit is described. The conventional magnetic circuit includes a yoke and a magnet. The magnet has an annular shape, and includes a first pole provided on an inner periphery and a second pole provided on an outer periphery. The magnet is magnetized from the first pole toward the second pole in a radial direction. The yoke includes a bottom part and a center pole. The center pole is provided at a central portion of the bottom part. Further, the center pole perpendicularly stands from the bottom part.

The second pole of the magnet is coupled with the yoke. Meanwhile, the first pole of the magnet is disposed facing a side surface of an outer periphery of the center pole. A magnetic gap is formed between the first pole of the magnet and the side surface of the outer periphery of the center pole.

As prior art information related to the invention of this application, Patent Document 1 is known, for example.

### CITATION LIST

### Patent Literature

PTL 1: Unexamined Japanese Patent Publication No. H1-300696

### SUMMARY OF THE INVENTION

However, in the conventional magnetic circuit, magnetic flux leaks to the center pole from a lower surface that faces a bottom surface in the magnet. The leaked magnetic flux makes a magnetic flux density at the lower end part of the magnetic gap larger than a magnetic flux density at the upper end part of the magnetic gap. That is, a magnetic flux density distribution in the magnetic gap becomes asymmetric and biased. When the voice coil inserted into the conventional magnetic circuit as thus described perpendicularly vibrates, disturbance occurs in the vibration of the voice coil due to the bias of the magnetic flux density distribution in the magnetic gap. There has thus been a problem of large distortion of sound of the loudspeaker.

Accordingly, the present disclosure is to solve this problem and has an object to provide a loudspeaker with small distortion of sound.

In order to achieve this object, a magnetic circuit of the present disclosure includes a yoke and a magnetic part. The yoke includes a bottom part and a first facing part. The first facing part is magnetically coupled with the bottom part. Note that the bottom part includes an upper surface and a lower surface, and the lower surface is provided on an opposite side from the upper surface.

Meanwhile, the magnetic part is coupled with the yoke. Further, the magnetic part includes a second facing part. The second facing part faces the first facing part through a magnetic gap. The magnetic part supplies magnetic force to the magnetic gap.

In the above configuration, the first facing part has a first upper end and a first lower end. Note that the first lower end is disposed at a position that is closer to the bottom part than the first upper end is. Further, the second facing part has a second upper end and a second lower end. The second upper end is disposed so as to be separated by a first distance from the first upper end. Meanwhile, the second lower end is disposed so as to be separated by a second distance from the first lower end. Moreover, the second lower end is disposed at a position that is closer to the bottom part than the second upper end is. The second distance is made greater than the first distance. Accordingly, the intended object can be achieved.

As described above, according to the present disclosure, since the second distance is greater than the first distance, magnetic resistance between the first upper end and the second upper end is smaller than magnetic resistance between the first lower end and the second lower end. Hence a magnetic flux density between the first upper end and the second upper end can be increased. As a result, the magnetic flux density between the first upper end and the second upper end increases. Further, the leakage of the magnetic flux at the second lower end can be made small. As a result, bias of the magnetic flux density distribution in the magnetic gap can be made small, and hence distortion of sound of the loudspeaker can be made small.

### BRIEF DESCRIPTION OF DRAWING

FIG. 1 is a top view of a loudspeaker in a first exemplary embodiment of the present disclosure.

FIG. 2A is a sectional view of a loudspeaker in the first exemplary embodiment of the present disclosure.

FIG. 2B is a sectional view of a preferable loudspeaker according to the present disclosure.

FIG. 3 is a sectional view, seen from the side surface, of a magnetic circuit included in the loudspeaker of the first exemplary embodiment of the present disclosure.

FIG. 4A is a characteristic diagram showing a magnetic characteristic of a magnetic circuit included in the loudspeaker of the first exemplary embodiment of the present disclosure.

FIG. 4B is a characteristic diagram showing a magnetic characteristic in a magnetic circuit of a comparative example.

FIG. 4C is an explanatory view showing a measurement point of a characteristic curve in the magnetic circuit of the loudspeaker of the first exemplary embodiment of the present disclosure and the magnetic circuit of the comparative example.

FIG. 5 is a top view according to Modified Example 1 of the magnetic circuit included in the loudspeaker of the first exemplary embodiment of the present disclosure.

FIG. 6 is a sectional view according to Modified Example 2 of the magnetic circuit included in the loudspeaker of the first exemplary embodiment of the present disclosure.

FIG. 7 is a sectional view according to Modified Example 3 of the magnetic circuit included in the loudspeaker of the first exemplary embodiment of the present disclosure.

FIG. 8 is a sectional view of an inner magnet type magnetic circuit in a second exemplary embodiment of the present disclosure.

FIG. 9 is a sectional view according to a modified example of the inner magnet type magnetic circuit in the second exemplary embodiment of the present disclosure.

FIG. 10 is a sectional view of an outer magnet type magnetic circuit in a third exemplary embodiment of the present disclosure.

FIG. 11 is a sectional view according to a modified example of the outer magnet type magnetic circuit in the third exemplary embodiment of the present disclosure.

### DESCRIPTION OF EXEMPLARY EMBODIMENTS

Hereinafter, a loudspeaker using a magnetic circuit in the present exemplary embodiment is described.

### First Exemplary Embodiment

Hereinafter, loudspeaker 51 in the present exemplary embodiment is described with reference to the drawings.

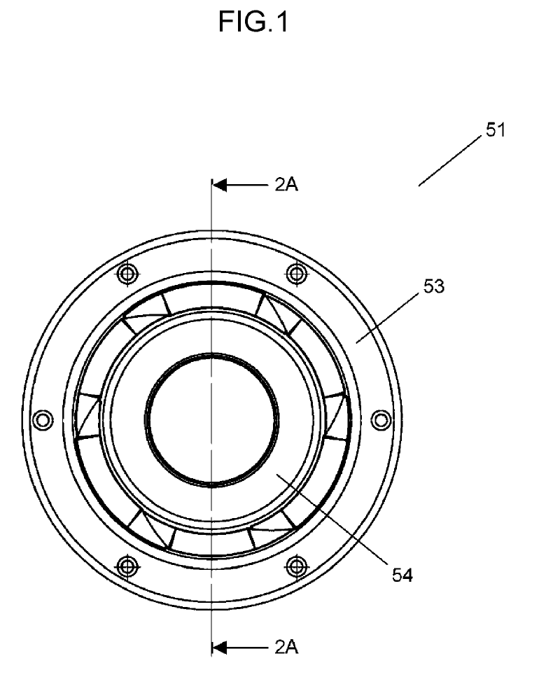

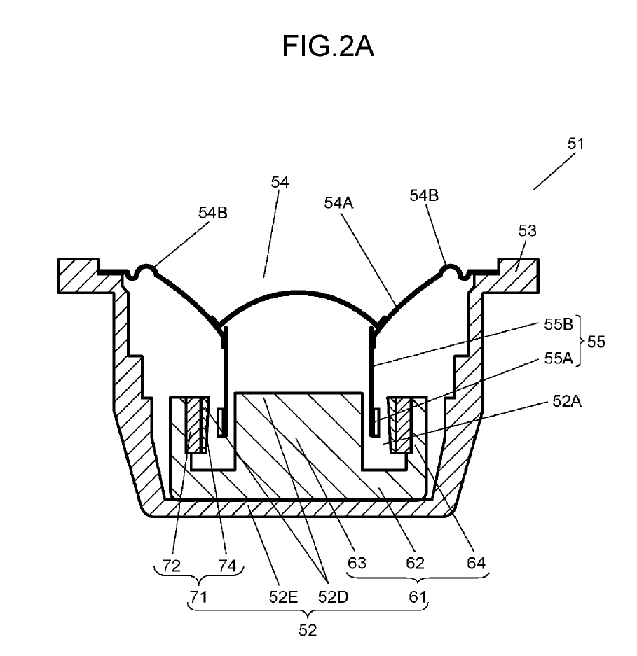

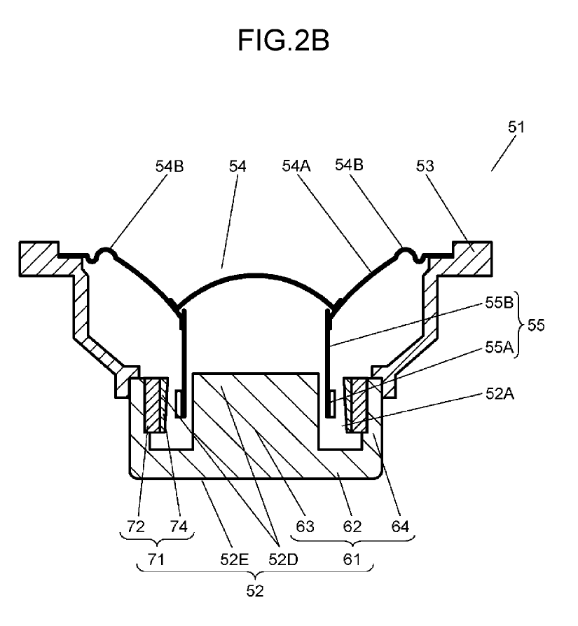

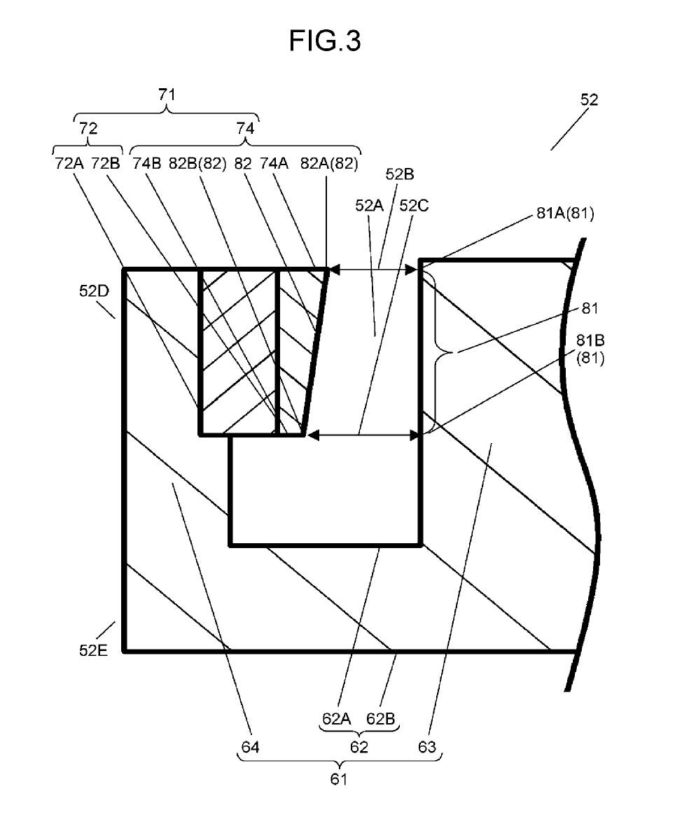

FIG. 1 is a top view of loudspeaker 51 according to the present exemplary embodiment. FIG. 2A is a sectional view of loudspeaker 51. FIG. 3 is an enlarged sectional view of magnetic circuit 52 included in loudspeaker 51. Note that FIG. 2A shows a sectional view obtained by cutting along sectional line 2A-2A of FIG. 1.

Loudspeaker 51 includes magnetic circuit 52 formed with magnetic gap 52A, frame 53, diaphragm 54, and voice coil body 55. The outer periphery of diaphragm 54 is coupled to frame 53. Voice coil body 55 has a first end part and a second end part. The first end part of voice coil body 55 is coupled to diaphragm 54. Meanwhile, the second end part of voice coil body 55 is inserted into magnetic gap 52A.

Magnetic circuit 52 includes yoke 61 and magnetic part 71. Yoke 61 includes bottom part 62 and first facing part 81. Bottom part 62 includes upper surface 62A and lower surface 62B. Note that lower surface 62B is provided on an opposite side of bottom part 62 from upper surface 62A.

Magnetic part 71 is coupled with yoke 61.

Further, magnetic part 71 includes second facing part 82. Second facing part 82 faces first facing part 81 through magnetic gap 52A. That is, magnetic gap 52A is formed between first facing part 81 and second facing part 82. Magnetic part 71 supplies magnetic force to magnetic gap 52A.

First facing part 81 has first upper end 81A and first lower end 81B. Note that first facing part 81 is magnetically coupled with bottom part 62 at first lower end 81B. Further, second facing part 82 has second upper end 82A and second lower end 82B. Second upper end 82A is disposed so as to be separated by first distance 52B from first upper end 81A. Meanwhile, second lower end 82B is disposed so as to be separated by second distance 52C from first lower end 81B. Second distance 52C is made greater than first distance 52B. Magnetic gap 52A is a space between first facing part 81 and second facing part 82. Magnetic gap 52A represents a space between a surface from second upper end 82A toward first facing part 81, the surface being perpendicular to first facing part 81, and a surface from second lower end 82B to first facing part 81, the surface being perpendicular to first facing part 81. First upper end 81A is located at an upper end of this space, and first lower end 81B is located at a lower end of this space.

According to the above configuration, with second distance 52C being greater than first distance 52B, magnetic resistance between first upper end 81A and second upper end 82A is smaller than magnetic resistance between first lower end 81B and second lower end 82B. Therefore, a magnetic flux density between first upper end 81A and second upper end 82A increases. As a result, bias of the magnetic flux density distribution in magnetic gap 52A can be made small, and hence distortion of sound of loudspeaker 51 can be made small.

(About Detail of Loudspeaker 51)

Hereinafter, loudspeaker 51 is described in further detail.

(Magnetic Circuit 52)

Magnetic circuit 52 is housed in frame 53. In this case, magnetic circuit 52 is fixed onto an inner surface of a central lower end part of frame 53.

(Diaphragm 54)

Diaphragm 54 is coupled to an inner peripheral front end of frame 53. Diaphragm 54 includes diaphragm body part 54A and edge 54B. In this case, edge 54B has an annular shape. An inner periphery of edge 54B is coupled to an outer periphery of diaphragm body part 54A. Meanwhile, an outer periphery of edge 54B is coupled to frame 53.

(Voice Coil Body 55)

Voice coil body 55 includes voice coil 55A and bobbin 55B. Bobbin 55B has a cylindrical shape. Voice coil 55A is wound on a side surface of an outer periphery of bobbin 55B. In this case, bobbin 55B is coupled to diaphragm 54.

Loudspeaker 51 further includes a terminal (not shown) and a conductor (not shown). The terminal is electrically connected with voice coil 55A. The conductor connects between terminal 56 and voice coil 55A. As the conductor, for example, a tinsel wire or the like can be used. With this configuration, a signal supplied to the terminal is supplied to voice coil 55A. Voice coil 55A then vibrates based on the signal supplied to terminal 56.

Next, magnetic circuit 52 is described with reference to FIG. 3. Magnetic circuit 52 has upper part 52D and lower part 52E being on the opposite side from upper part 52D. Magnetic gap 52A is formed in upper part 52D of magnetic circuit 52.

(Yoke 61)

Yoke 61 is formed of magnetic metal. Yoke 61 is formed of iron or the like, for example. Yoke 61 further includes center pole 63. Center pole 63 is provided at a central portion of bottom part 62. Moreover, center pole 63 has a columnar shape and projects from bottom part 62 toward upper part 52D.

Center pole 63 is integrally formed with bottom part 62.

(First Facing Part 81)

First facing part 81 is formed on an outer peripheral side surface of center pole 63.

(Magnetic Part 71)

Magnetic part 71 includes magnet 72 that supplies magnetic force to magnetic gap 52A. Magnet 72 has first pole 72A and second pole 72B. Note that second pole 72B is formed on an opposite side from first pole 72A. Moreover, first pole 72A and second pole 72B are parallel to each other. First pole 72A is magnetically coupled with yoke 61. For example, when first pole 72A is a south pole, second pole 72B is a north pole.

Magnetic part 71 further includes annular first plate 74. First plate 74 is formed of iron or the like, for example. First plate 74 is coupled to second pole 72B. In this case, first plate 74 includes second facing part 82. With this configuration, magnetic force generated by magnet 72 can be concentrated on magnetic gap 52A.

(First Plate 74)

First plate 74 has first surface 74A and second surface 74B. First surface 74A is coupled with second facing part 82 at second upper end 82A. Meanwhile, second surface 74B is coupled with second facing part 82 at second lower end 82B. That is, second surface 74B is disposed facing upper surface 62A of bottom part 62. First surface 74A is formed on an opposite surface of first plate 74 from second surface 74B. When first facing part 81 is provided so as to stand perpendicularly to the upper surface of bottom part 62, an area of second surface 74B is small as compared with an area of first surface 74A. Hence magnetic flux leaked from first surface 74A can be made small. As a result, a distribution of a magnetic flux density of magnetic gap 52A can further be made uniform.

(About Characteristic of Magnetic Circuit 52)

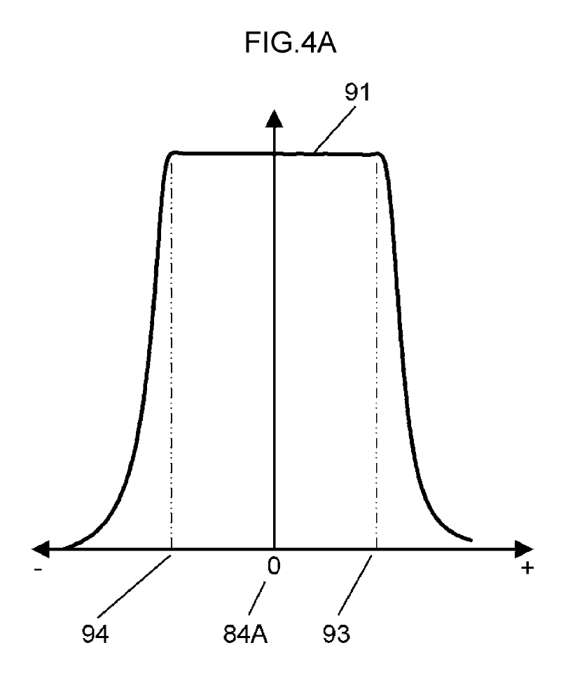

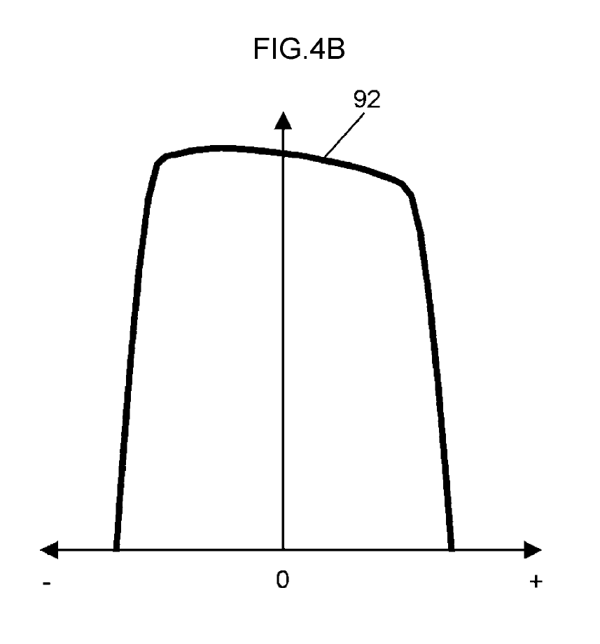

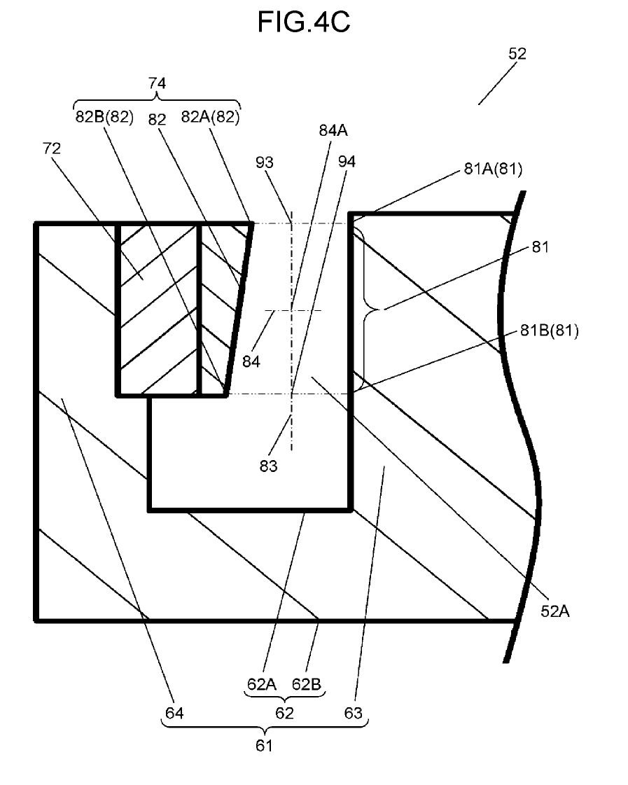

A magnetic characteristic of magnetic circuit 52 configured as described above is described with reference to the drawings. FIG. 4A is a characteristic diagram showing a magnetic characteristic of magnetic circuit 52 shown in FIG. 3. Characteristic curve 91 shows a magnetic characteristic of magnetic circuit 52 shown in FIG. 3. FIG. 4B is a characteristic diagram showing a magnetic characteristic of a magnetic circuit of a comparative example (a magnetic circuit formed as making first distance 52B and second distance 52C equal). FIG. 4C is an explanatory view showing a measurement point of a characteristic curve. Characteristic curve 92 shows the magnetic characteristic of the magnetic circuit of the comparative example.

In FIGS. 4A and 4B, a vertical axis shows a magnitude of a magnetic flux density in the magnetic gap. Note that characteristic curve 91 of FIG. 4A is obtained by observation of a magnetic flux density on center line 83 that passes through a middle point between first upper end 81A and second upper end 82A shown in FIG. 4C and is parallel to first facing part 81. Further, as shown in FIG. 4C, center line 84 and center line 83 intersects with each other at point 84A, center line 84 connecting between a center of first facing part 81 and a center of second facing part 82. A horizontal axis of FIG. 4A shows a distance from point 84A on center line 83 shown in FIG. 4C. Note that in FIG. 4A, a right direction from point 84A is taken as a plus, and a left direction from point 84A is taken as a minus.

Further, a line connecting between first upper end 81A and second upper end 82A shown in FIG. 4C intersects with center line 83 at point 93. As shown in FIG. 4A, point 93 is disposed in the right direction from point 84A. a line connecting between first lower end 81B and second lower end 82B shown in FIG. 4C intersects with center line 83 at point 94. As shown in FIG. 4A, point 94 is disposed in the left direction from point 84A. That is, in FIG. 4C, a direction toward point 93 from point 84A is a plus. Further, in FIG. 4C, a direction toward point 94 from point 84A is a minus.

Hence a magnetic flux density at point 84A shows a magnetic flux density on center line 84 in magnetic gap 52A shown in FIG. 4C. Further, a magnetic flux density at point 93 shows a magnetic flux density between first upper end 81A and second upper end 82A shown in FIG. 4C. Moreover, a magnetic flux density at point 94 shows a magnetic flux density between first lower end 81B and second lower end 82B shown in FIG. 4C.

As shown in characteristic curve 92 of FIG. 4B, in the magnetic circuit of the comparative example, the magnetic flux density distribution in the magnetic gap is biased. In particular, the plus-side and minus-side characteristic curves of the magnetic flux density have no symmetry. In a case where voice coil 55A shown in FIG. 2A is disposed in such a conventional magnetic circuit, when voice coil 55A vibrates, disturbance occurs in the vibration due to the bias of the magnetic flux density distribution.

Meanwhile, as shown in FIG. 4A, a difference between the magnetic flux density at point 94 and the magnetic flux density at point 93 on characteristic curve 91 is small. Further, on characteristic curve 91, the symmetry of the plus-side magnetic flux density and the minus-side magnetic flux density with respect to center line 84 shown in FIG. 4C is improved. This leads to a small bias of the magnetic flux density distribution in magnetic gap 52A shown in FIG. 4C. The disturbance of the vibration of voice coil 55A shown in FIG. 2A, which is disposed in magnetic gap 52A, can be made small. This leads to reduction in disturbance of vibration of diaphragm 54, thus enabling reduction in distortion of the sound that is output from loudspeaker 51.

As shown in FIG. 3, second facing part 82 has a shape formed by linearly connecting second upper end 82A to second lower end 82B. With this configuration, on characteristic curve 91 shown in FIG. 4A, flatness of the magnetic flux density characteristic between point 93 and point 94 is also improved. Hence the bias of the magnetic flux density distribution in magnetic gap 52A can be made small. Note that the flatness of the magnetic flux density characteristic between point 93 and point 94 shown in FIG. 4C can be adjusted by appropriately changing the shape of second facing part 82. Further, a shape, as seen from the upper-part-52D side, of magnetic circuit 52 shown in FIG. 2A is not restricted to a circular shape, but may be a rectangular shape, a track shape, or an elliptical shape. First plate 74 may further include a bent part (not shown). The bent part is bent from first plate 74. The bent part is disposed so as to go along a lower surface of magnet 72. With this configuration, magnetic flux leaked from the lower surface of magnet 72 toward center pole 63 can be reduced.

### Preferred Exemplary Configuration Other than Above Configuration

Note that magnetic circuit 52 is not restrictively configured to be housed in frame 53 as shown in FIG. 2A, but may be disposed outside frame 53 as shown in FIG. 2B. In this case, magnetic circuit 52 is coupled to an outer surface of the central lower end part of frame 53.

Note that voice coil body 55 is not restrictively configured to include bobbin 55B, but may be configured not to include bobbin 55B. In this case, voice coil 55A is coupled directly to diaphragm 54.

Note that first facing part 81 is preferably provided so as to stand perpendicularly to the upper surface of bottom part 62. In this case, second facing part 82 is disposed so as to be inclined with respect to first facing part 81. With this configuration, second distance 52C can be made larger than first distance 52B. Further, the number of steps for producing center pole 63 can be reduced.

Note that first plate 74 is not restrictively configured to have second surface 74B, but may not be provided with second surface 74B. In this case, first surface 74A and second surface 74B are preferably flat. With this configuration, the areas of first surface 74A and second surface 74B can be made small. Hence magnetic flux leaked from first surface 74A and second surface 74B can be made even smaller. Note that first surface 74A and second surface 74B are not restrictively configured to be flat. First surface 74A and second surface 74B may be bent. Alternatively, first surface 74A and second surface 74B may appropriately include a projection, a recess, or the like.

It is preferable that first surface 74A and second surface 74B stand perpendicularly to second pole 72B. With this configuration, the areas of first surface 74A and second surface 74B can be made small. Hence magnetic flux leaked from first surface 74A and second surface 74B can be made even smaller. Note that first surface 74A and second surface 74B are not restrictively configured to stand perpendicularly to second pole 72B, but may be inclined with respect to second pole 72B. In this case, it is preferable that a gap between first surface 74A and second surface 74B gradually narrow from a side coupled to second pole 72B toward magnetic gap 52A. With this configuration, the area of second pole 72B can be made large. Since a volume of magnet 72 can thus be made large, the magnetic flux density in magnetic gap 52A can be made large.

First surface 74A is disposed so as to intersect with second facing part 82 at a first angle.

Further, second surface 74B is disposed so as to intersect with second facing part 82 at a second angle. Typically, magnetism which is output from magnet 72 concentrates on corner portions of first plate 74. That is, the magnetism concentrates on second upper end 82A and second lower end 82B. Then, the second angle is made larger than the first angle. Note that the first angle is preferably an acute angle. Moreover, second angle is preferably an obtuse angle. With this configuration, the magnetic force concentrates on second upper end 82A. That is, the magnetic flux density at second lower end 82B becomes small as compared with the magnetic flux density at second upper end 82A. Hence magnetic flux leaked from second lower end 82B can be made small. With this configuration, the bias of the magnetic flux density distribution in magnetic gap 52A can be made even smaller.

Magnet 72 is preferably magnetized in a radial direction. A shape of magnet 72 seen from above is an annular shape. In this case, first pole 72A is formed on an outer peripheral side surface of magnet 72. Meanwhile, second pole 72B is formed on an inner peripheral side surface of magnet 72. Therefore, first plate 74 is coupled to an inside of second pole 72B of magnet 72. That is, second facing part 82 is formed on a side surface on an opposite side of first plate 74 from a side surface coupled with second pole 72B.

It is preferable that yoke 61 further include cylindrical part 64. Cylindrical part 64 is formed as bent from an outer peripheral end part of bottom part 62. Note that cylindrical part 64 is magnetically coupled with bottom part 62. In this case, cylindrical part 64 stands perpendicularly to upper surface 62A of bottom part 62. That is, an inner peripheral side surface of cylindrical part 64 stands perpendicularly to upper surface 62A of bottom part 62. By coupling first pole 72A to the inner peripheral side surface of the cylindrical part, first pole 72A is magnetically coupled with yoke 61. With this configuration, the magnetic flux can be concentrated on magnetic gap 52A, to improve the magnetic flux density in magnetic gap 52A.

As shown in FIG. 1, the shape, seen from the upper-part-52D side, of magnetic circuit 52 shown in FIG. 2A is preferably a circular shape. With this configuration, the distortion of the sound of loudspeaker 51 can be reduced. Further, it is possible to reduce a collision between voice coil 55A and magnetic circuit 52 shown in FIG. 2A. In this case, bottom part 62 has a disk shape, and center pole 63 has a cylindrical shape. Hence cylindrical part 64 and bobbin 55B each have a cylindrical shape. Moreover, magnet 72 and first plate 74 each have an annular shape.

### Modified Example 1 of Magnetic Circuit 52 Included in Loudspeaker 51 of First Exemplary Embodiment

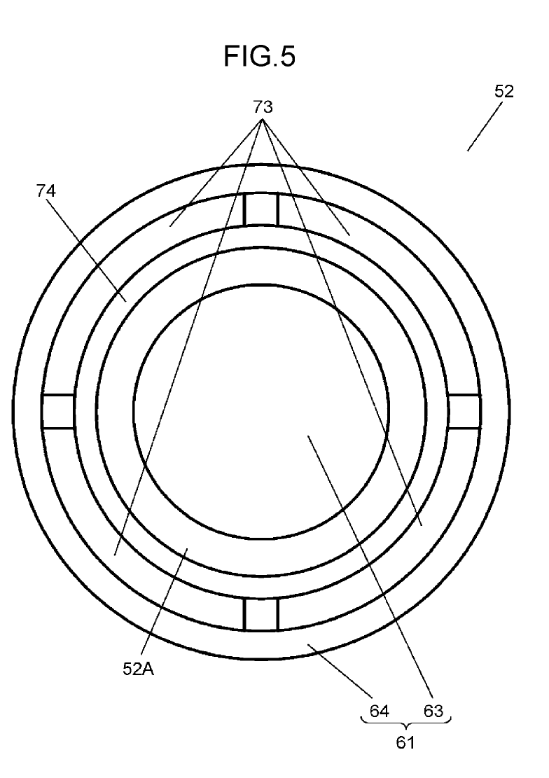

FIG. 5 is a top view of magnetic circuit 52, according to Modified Example 1, included in loudspeaker 51. Magnet 72 may be formed of divided magnets 73. In this case, a plurality of divided magnets 73 are disposed annularly to form magnet 72. Adjacent divided magnets 73 are preferably brought into close contact with each other. Note that adjacent divided magnets 73 are not restrictively configured to be brought into close contact with each other, but may be disposed separately from each other. In this case, first poles 72A of adjacent divided magnets 73 are configured to be cross-linked by cylindrical part 64. Further, second poles 72B of adjacent divided magnets 73 are configured to be cross-linked by first plate 74. With this configuration, it is possible to reduce occurrence of the bias of the magnetic flux density in a peripheral direction of magnetic gap 52A.

As shown in FIG. 3, magnetic part 71 is configured of magnet 72 and first plate 74, but this configuration is not restrictive. For example, magnetic part 71 may be formed of a bonded magnet. In this case, magnet 72 is formed of the bonded magnet. It is preferable that first plate 74 also be formed of the bonded magnet. Note that first plate 74 is magnetized in the same direction as a direction in which magnet 72 is magnetized. It is preferable to form magnet 72 and first plate 74 integrally. With this configuration, operation of bonding magnet 72 with first plate 74 is unnecessary. This leads to excellent productivity of magnetic part 71.

### Modified Example 2 of Magnetic Circuit 52 Included in Loudspeaker 51 of First Exemplary Embodiment

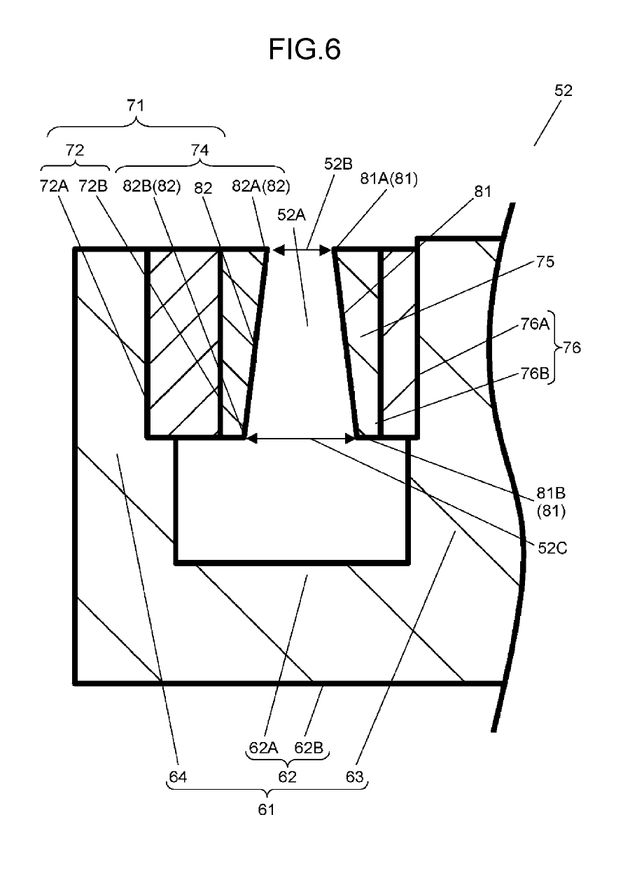

FIG. 6 is a sectional view of magnetic circuit 52, according to Modified Example 2, having a second plate and being included in loudspeaker 52. Magnetic circuit 52 may include second plate 75. Second plate 75 is magnetically coupled with center pole 63. In this case, first facing part 81 is formed in second plate 75. First facing part 81 is inclined with respect to a perpendicular line of upper surface 62A of bottom part 62. In this case, second facing part 82 is not restrictively configured to be inclined with respect to the perpendicular line of upper surface 62A of bottom part 62, but may be provided perpendicularly to upper surface 62A of bottom part 62. Moreover, magnetic circuit 52 is not restrictively configured to be provided with first plate 74, but first plate 74 may not be provided. In this case, second facing part 82 is formed on second pole 72B of magnet 72.

Magnetic circuit 52 may include second magnet 76. With this configuration, the magnetic flux density in magnetic gap 52A can be made large. Magnetic flux of magnet 72 and magnetic flux of second magnet 76 are oriented in the same direction. That is, second magnet 76 also has first pole 76A and second pole 76B, and first pole 76A of second magnet 76 is coupled to center pole 63. With this configuration, second magnet 76 is disposed in such an orientation as to be magnetically connected in series to magnet 72. Therefore, second plate 75 is coupled to second pole 76B of second magnet 76. That is, second magnet 76 is provided between second plate 75 and center pole 63.

Although magnetic circuit 52 is configured to include second plate 75, this configuration is not restrictive. Magnetic circuit 52 may be configured not to include second plate 75. In this case, first facing part 81 is formed in second pole 76B of second magnet 76. In this case, first facing part 81 is disposed perpendicularly to upper surface 62A of bottom part 62.

Magnetic circuit 52 may be configured not to include second magnet 76. In this case, second plate 75 is coupled directly to the outer peripheral side surface of center pole 63. Hence center pole 63 and second plate 75 may be formed integrally. Moreover, second facing part 82 may be provided so as to be perpendicular to bottom part 62. As a result, first facing part 81 is disposed so as to be inclined with respect to second facing part 82. In this case, second facing part 82 may be formed on second pole 72B of magnet 72. That is, magnetic gap 52A can be formed between second pole 72B and first facing part 81. Accordingly, first plate 74 is unnecessary.

### Modified Example 3 of Magnetic Circuit 52 Included in Loudspeaker 51 of First Exemplary Embodiment

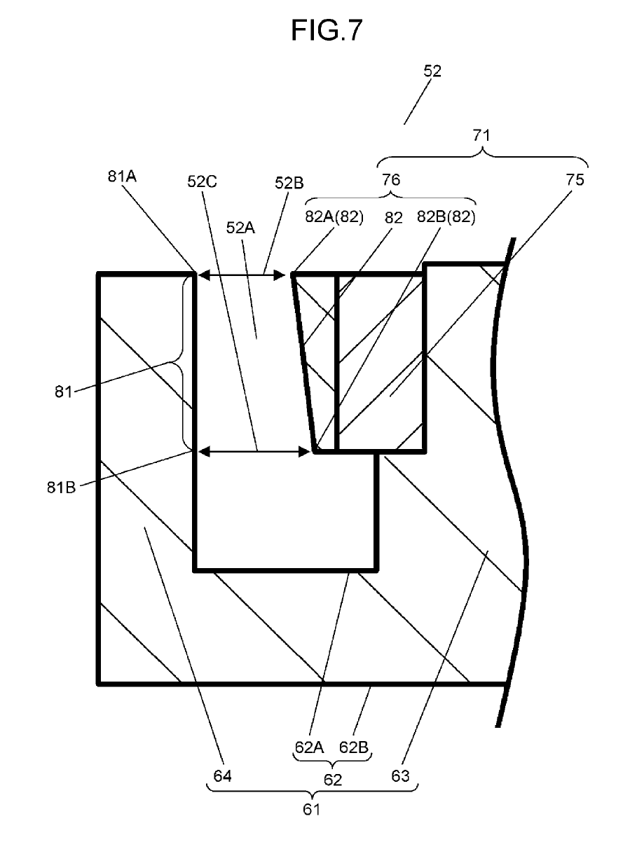

FIG. 7 is a sectional view of magnetic circuit 52, according to Modified Example 3, in which magnetic part 71 is provided in center pole 63, the magnetic circuit 52 being included in loudspeaker 51. Magnetic circuit 52 in this case may not include magnet 72 in FIG. 6. In this case, magnetic part 71 is formed of second plate 75 and second magnet 76. Second magnet 76 thus includes second facing part 82, second upper end 82A, and second lower end 82B. Meanwhile, first facing part 81, first upper end 81A, and first lower end 81B may be formed on the inner peripheral side surface of cylindrical part 64. In this case, magnetic circuit 52 does not include first plate 74 in FIG. 6. Note that magnetic circuit 52 is not restrictively configured not to include first plate 74 in FIG. 6, but may be configured to include first plate 74.

### Second Exemplary Embodiment

Hereinafter, a loudspeaker in a second exemplary embodiment, especially magnetic circuit 152, is described with reference to the drawings. A configuration of the loudspeaker other than magnetic circuit 152 is similar to the configuration of loudspeaker 51 of the first exemplary embodiment.

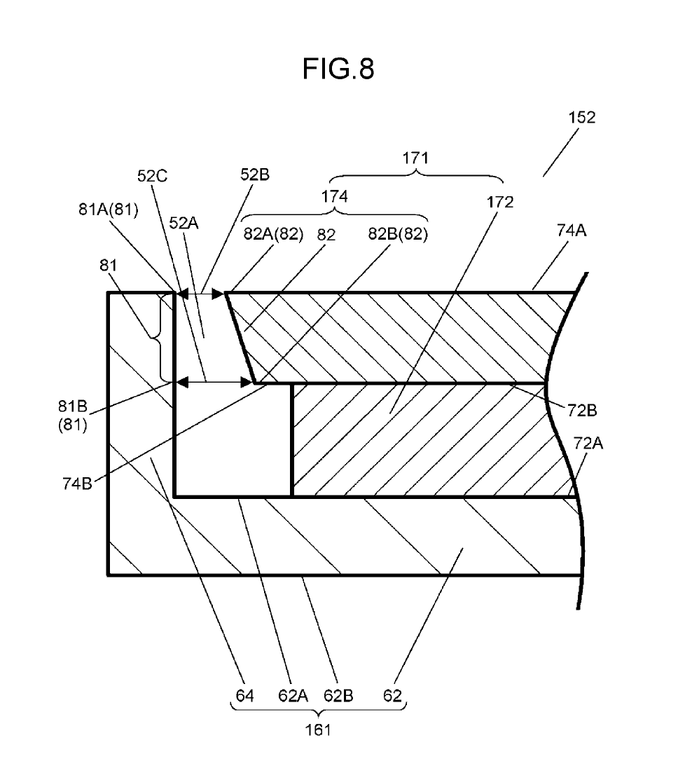

FIG. 8 is a sectional view of magnetic circuit 152. Magnetic circuit 152 is an inner magnet type. Magnetic circuit 152 includes yoke 161 and magnetic part 171. Magnetic part 171 includes magnet 172 and first plate 174. Yoke 161 includes bottom part 62 and cylindrical part 64. Hence magnet 172 is mounted at a central portion of upper surface 62A of bottom part 62. First pole 72A of magnet 172 is magnetically coupled with bottom part 62. First plate 174 is coupled with second pole 72B of magnet 172.

Magnet 172 has a columnar shape, and first plate 174 has a flat shape. Note that a shape of magnetic circuit 152 seen from above preferably has a circular shape. In this case, magnet 172 has a cylindrical shape. First plate 174 has a disk shape. Magnetic gap 52A is formed between an outer peripheral side surface of first plate 174 and an inner peripheral side surface of cylindrical part 64. In this case, second facing part 82, second upper end 82A, and second lower end 82B are formed on the outer peripheral side surface of first plate 174. Meanwhile, first facing part 81, first upper end 81A, and first lower end 81B are formed on the inner peripheral side surface of cylindrical part 64. Hence first facing part 81 is disposed perpendicularly to upper surface 62A of bottom part 62. Second facing part 82 is disposed so as to be inclined with respect to first facing part 81.

### Modified Example of Magnetic Circuit 152 Included in Loudspeaker of Second Exemplary Embodiment

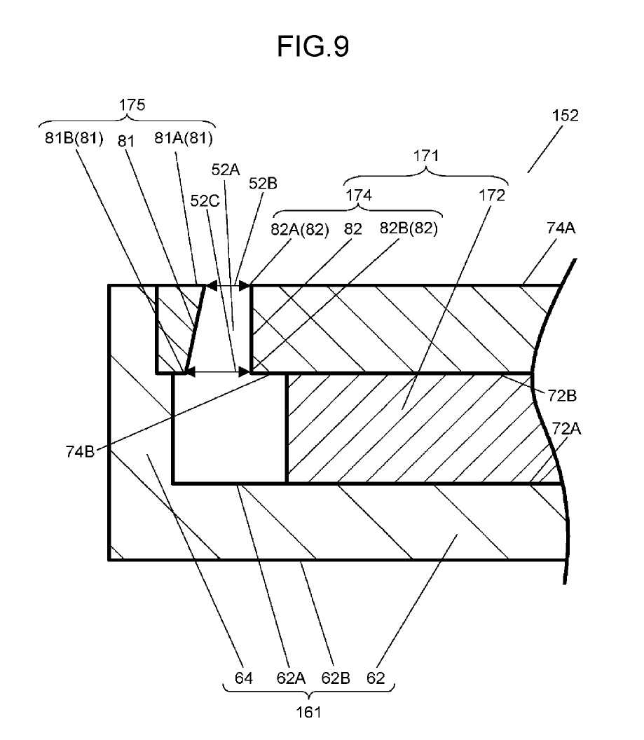

FIG. 9 is a sectional view of magnetic circuit 152, according to a modified example, having ring 175 and being included in the above loudspeaker. Magnetic circuit 152 may further include ring 175. Ring 175 includes first facing part 81. Ring 175 is coupled with the inner peripheral side surface of cylindrical part 64. Second facing part 82 is disposed perpendicularly to upper surface 62A of bottom part 62. First facing part 81 is disposed so as to be inclined with respect to second facing part 82. Although ring 175 is configured as a separate component from cylindrical part 64, this configuration is not restrictive. Ring 175 and cylindrical part 64 may be formed integrally. Note that second facing part 82 is not restrictively configured to be disposed perpendicularly to upper surface 62A of bottom part 62, but may be provided so as to be inclined with respect to upper surface 62A of bottom part 62.

### Third Exemplary Embodiment

Hereinafter, a loudspeaker in a third exemplary embodiment, especially a magnetic circuit, is described with reference to the drawings.

Hereinafter, the loudspeaker in the third exemplary embodiment, especially magnetic circuit 252, is described with reference to the drawings. A configuration of the loudspeaker other than magnetic circuit 252 is similar to the configuration of loudspeaker 51 of the first exemplary embodiment.

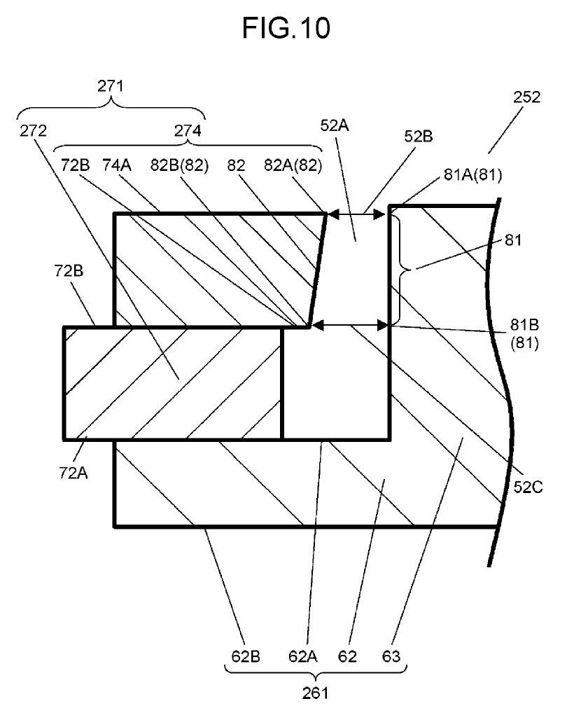

FIG. 10 is a sectional view of magnetic circuit 252. Magnetic circuit 252 is an outer magnet type. Magnetic circuit 252 includes yoke 261 and magnetic part 271. Yoke 261 includes bottom part 62 and center pole 63. In this case, each of magnet 272 and first plate 274 has an annular shape and is formed with a through hole at a central portion. Note that a shape of magnetic circuit 252 seen from above preferably has a circular shape. In this case, magnet 272 has a cylindrical shape. First plate 274 has a disk shape.

First pole 72A of magnet 272 is mounted on upper surface 62A of bottom part 62. First plate 274 is coupled to a top of second pole 72B of magnet 272. Center pole 63 is inserted into the through holes of magnet 272 and first plate 274. With this configuration, magnetic gap 52A is formed between an inner peripheral side surface of first plate 274 and the outer peripheral side surface of center pole 63. In this case, second facing part 82 is formed on the inner peripheral side surface of first plate 274. Meanwhile, first facing part 81 is formed on center pole 63. Second facing part 82 is disposed so as to be inclined with respect to first facing part 81.

Although magnetic circuit 252 is an outer magnet type, this configuration is not restrictive. Magnetic circuit 252 may be configured in combination of the outer magnet type with the inner magnet type. In this case, magnetic circuit 252 includes magnet 172 and first plate 174 shown in FIG. 8, in place of center pole 63.

### Modified Example of Magnetic Circuit 252 Included in Loudspeaker of Third Exemplary Embodiment

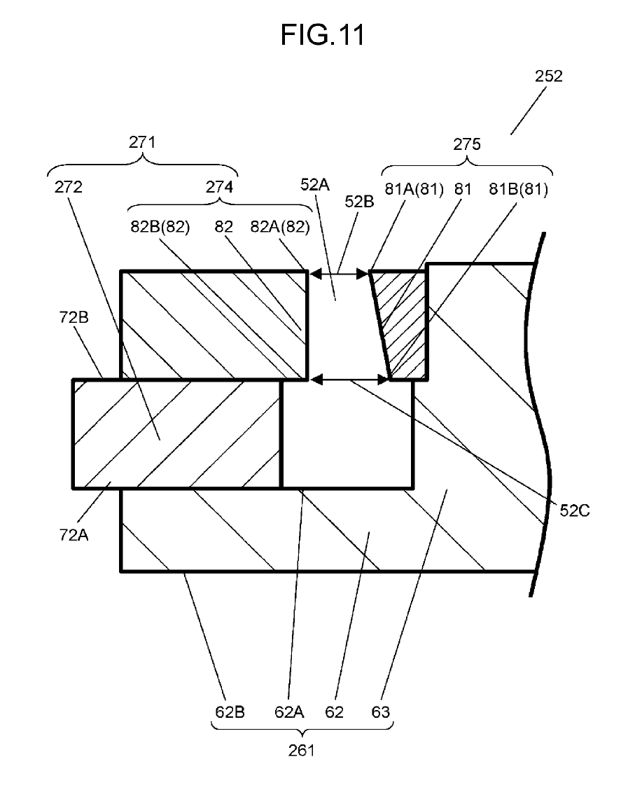

FIG. 11 is a sectional view of magnetic circuit 252, according to a modified example, having ring 275 and being included in the above loudspeaker. Magnetic circuit 252 may include ring 275. Ring 275 is coupled to the outer peripheral side surface of center pole 63. In this case, first facing part 81 is provided on ring 275. Note that second facing part 82 is disposed perpendicularly to upper surface 62A of bottom part 62. First facing part 81 is inclined with respect to second facing part 82.

Note that second facing part 82 is not restrictively configured to be disposed perpendicularly to upper surface 62A of bottom part 62, but may be provided so as to be inclined with respect to upper surface 62A of bottom part 62.

### INDUSTRIAL APPLICABILITY

A magnetic circuit according to the present invention has an effect where deviation of a magnetic flux density distribution in a magnetic gap can be made small, and is useful when applied to a loudspeaker or the like which is used for various types of audio equipment.

### REFERENCE MARKS IN THE DRAWINGS

51 loudspeaker

52 magnetic circuit

52A magnetic gap

52B first distance

52C second distance

52D upper part

52E lower part

53 frame

54 diaphragm

54A diaphragm body part

54B edge

55 voice coil body

55A voice coil

55B bobbin

61 yoke

62 bottom part

62A upper surface

62B lower surface

63 center pole

64 cylindrical part

71 magnetic part

72 magnet

72A first pole

72B second pole

73 divided magnet

74 first plate

74A first surface

74B second surface

75 second plate

76 second magnet

76A first pole

76B second pole

81 first facing part

81A first upper end

81B first lower end

82 second facing part

82A second upper end

82B second lower end

83 center line

84 center line

84A point

91 characteristic curve

92 characteristic curve

93 point

94 point

152 magnetic circuit

161 yoke

171 magnetic part

172 magnet

174 first plate

175 ring

252 magnetic circuit

261 yoke

271 magnetic part

272 magnet

274 first plate

275 ring

1. A magnetic circuit comprising:
a yoke that includes a bottom part having an upper surface and a lower surface being on an opposite side from the upper surface, and a first facing part having a first upper end and a first lower end which is closer to the bottom part than the first upper end is, the first facing part being magnetically connected with the bottom part; and
a magnetic part that includes a second facing part having a second upper end disposed so as to be separated by a first distance from the first upper end, and a second lower end disposed so as to be closer to the bottom part than the second upper end is and be separated by a second distance greater than the first distance from the first lower end, the second facing part facing the first facing part through a magnetic gap, the magnetic part being coupled with the yoke so as to supply magnetic force to the magnetic gap.

2. The magnetic circuit according to claim 1, wherein
the first facing part is provided perpendicularly to the bottom part, and
the second facing part is inclined with respect to the first facing part.

3. The magnetic circuit according to claim 2, wherein the magnetic part has an annular magnet magnetized in a radial direction.

4. The magnetic circuit according to claim 3, wherein the magnet is formed by annularly disposing a plurality of divided magnets.

5. The magnetic circuit according to claim 3, wherein the magnetic part is formed of a bonded magnet.

6. The magnetic circuit according to claim 1, wherein the magnetic part includes a magnet having a first pole coupled to the yoke and a second pole being on an opposite side from the first pole, and an annular plate coupled to the second pole and having the second facing part.

7. The magnetic circuit according to claim 6, wherein the first pole of the magnet is mounted on the upper surface of the bottom part.

8. The magnetic circuit according to claim 6, wherein the plate has a first surface coupled with the second facing part at the second upper end and intersecting with the second facing part at a first angle, and a second surface coupled with the second facing part at the second lower end and intersecting with the second facing part at a second angle that is larger than the first angle.

9. The magnetic circuit according to claim 8, wherein the first angle is an acute angle.

10. The magnetic circuit according to claim 8, wherein the second angle is an obtuse angle.

11. The magnetic circuit according to claim 1, wherein
the second facing part is provided so as to stand perpendicularly to the bottom part, and
the first facing part is inclined with respect to the second facing part.

12. The magnetic circuit according to claim 1, wherein the first facing part and the second facing part are inclined with respect to a perpendicular line of the upper surface of the bottom part.

13. A loudspeaker comprising:
a frame;
a diaphragm with an outer periphery coupled to the frame;
a voice coil body having a first end part and a second end part, the first end part being coupled to the diaphragm, the second end part being inserted into a magnetic gap; and
a magnetic circuit including
a yoke that includes a bottom part having an upper surface and a lower surface on an opposite side from the upper surface, and a first facing part having a first upper end and a first lower end, the first facing part being magnetically connected with the bottom part at the first lower end, and
a magnetic part that includes a second facing part having a second upper end disposed so as to be separated by a first distance from the first upper end, and a second lower end disposed so as to be separated by a second distance greater than the first distance from the first lower end, the second facing part facing the first facing part through the magnetic gap, and is coupled with the yoke so as to supply magnetic force to the magnetic gap.
